(19) United States
(12) Patent Application Publication
(10) Pub. No.: US 2026/0095361 A1
(43) Pub. Date: Apr. 2, 2026

(54) INFORMATION REPORTING METHOD AND APPARATUS THEREOF

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(73) Assignee: BEIJING XIAOMI MOBILE SOFTWARE CO., LTD., Beijing (CN)

(21) Appl. No.: 19/113,467

(22) PCT Filed: Sep. 29, 2022
(86) PCT No.: PCT/CN2022/122937

§ 371 Date: Mar. 20, 2025

(51) Int. Cl. H04L 27/26; H04L 5/00; H04W 24/10

(52) U.S. Cl. CPC H04L 27/2678; H04L 5/0005; H04W 24/10

(57) ABSTRACT

A method for reporting information includes: sending measurement configuration information to a terminal, the measurement configuration information indicating to the terminal a candidate TRP for a channel quality measurement; sending a reference signal of the candidate TRP to the terminal, the reference signal being used for the terminal to measure the candidate TRP; and receiving a recommended CP length and/or a recommended TRP sent by the terminal, the recommended CP length and/or the recommended TRP being determined by the terminal according to a measurement result of the candidate TRP.

### CROSS-REFERENCE TO RELATED APPLICATION

The present application is a U.S. national phase of International Application No. PCT/CN2022/122937, filed with the State Intellectual Property Office of P. R. China on Sep. 29, 2022, the contents of which are incorporated herein by reference in their entireties for all purposes.

### TECHNICAL FIELD

The present disclosure relates to the field of communication technology, and specifically to a method and an apparatus for reporting information.

### BACKGROUND

In a distributed multiple-input-multiple-output (MIMO) system, for a terminal (also known as user equipment (UE)), a plurality of base stations may serve the UE at the same time, and a plurality of transmit/receive points (TRPs) serve one UE. In this way, signal quality is better guaranteed, and service requirements of high speed and high capacity of the UE may be met.

However, in the distributed MIMO system, cooperative transmission among the plurality of TRPs is a key to improve system performance. Due to different positions of different TRPs relative to the UE, multipath delays may also be different, so it is necessary to select appropriate cyclic prefix (CP) lengths to cover different multipath delays.

### SUMMARY

In a first aspect, the embodiments of the present disclosure provide a method for reporting information, performed by a network device, including:
sending measurement configuration information to a terminal, in which the measurement configuration information indicates a candidate TRP for a channel quality measurement to the terminal;
sending a reference signal of the candidate TRP to the terminal, in which the reference signal is used for the terminal to measure the candidate TRP; and
receiving a recommended CP length and/or a recommended TRP sent by the terminal, in which the recommended CP length and/or the recommended TRP is determined by the terminal based on a measurement result of the candidate TRP.

In a second aspect, the embodiments of the present disclosure provide a method for reporting information, performed by a terminal, including:
receiving measurement configuration information of a candidate TRP sent by a network device, in which the measurement configuration information indicates the candidate TRP for a channel quality measurement to the terminal;
receiving a reference signal of the candidate TRP sent by the network device, and determining a measurement result of the candidate TRP according to the reference signal of the candidate TRP; and
determining a recommended CP length and a recommended TRP based on the measurement result of the candidate TRP, and reporting the recommended CP length and the recommended TRP to the network device.

In a third aspect, the embodiments of the present disclosure provide a communication apparatus, including a processor and a memory for storing a computer program. When the computer program stored in the memory is executed by the processor, the communication apparatus is caused to implement the method in the first aspect.

In a fourth aspect, the embodiments of the present disclosure provide a communication apparatus, including a processor and a memory for storing a computer program. When the computer program stored in the memory is executed by the processor, the communication apparatus is caused to implement the method in the second aspect.

### BRIEF DESCRIPTION OF THE DRAWINGS

In order to clearly illustrate technical solutions of embodiments of the present disclosure or background, a brief description of drawings used in embodiments and the background is given below.

FIG. 1 is a schematic diagram of an architecture of a communication system according to an embodiment of the present disclosure.

FIG. 2 is a flowchart of a method for reporting information according to an embodiment of the present disclosure.

FIG. 3 is a flowchart of a method for reporting information according to an embodiment of the present disclosure.

FIG. 4 is a flowchart of a method for reporting information according to an embodiment of the present disclosure.

FIG. 5 is a flowchart of a method for reporting information according to an embodiment of the present disclosure.

FIG. 6 is a flowchart of a method for reporting information according to an embodiment of the present disclosure.

FIG. 7 is a flowchart of a method for reporting information according to an embodiment of the present disclosure.

FIG. 8 is a flowchart of a method for reporting information according to an embodiment of the present disclosure.

FIG. 9 is a block diagram of a communication apparatus according to an embodiment of the present disclosure.

FIG. 10 is a block diagram of a communication device according to an embodiment of the present disclosure.

FIG. 11 is a block diagram of a chip according to an embodiment of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terms used in the embodiments of the present disclosure are solely for the purpose of describing a particular embodiment and are not intended to limit the embodiments of the present disclosure. The terms “a” and “the” in the singular form used in the embodiments and claims of the disclosure are also intended to include the plural form, unless the context clearly indicates other meaning. It may be understood that the term “and/or” as used herein refers to any or all possible combinations of one or more associated listed items.

It may be understood that although the terms first, second, third, etc. may be used to describe various information in the embodiments of the present disclosure, such information should not be limited to these terms. These terms are used only to distinguish information in the same type from one another. For example, without leaving the scope of this embodiments of the present disclosure, the first information may also be referred to as the second information, and likewise the second information may be referred to as the first information. Depending on a context, words “if” and “in case that” used here may be interpreted as “when”, “while”, or “in response to determining. . . ” For a sake of simplicity and ease of understanding, terms “greater than” or “less than’, “higher than” or “lower than” are used in the present disclosure when representing a size relationship. However, for those skilled in the art, it may be understood that the term “greater than” also covers a meaning of “greater than or equal to” and “less than” also covers a meaning of “less than or equal to”; the term “higher than” covers a meaning of “higher than or equal to”, and “lower than” also covers a meaning of “lower than or equal to”.

In order to better understand a method for reporting information in the embodiments of the present disclosure, the communication system to which the embodiments of the present disclosure are applicable is firstly described.

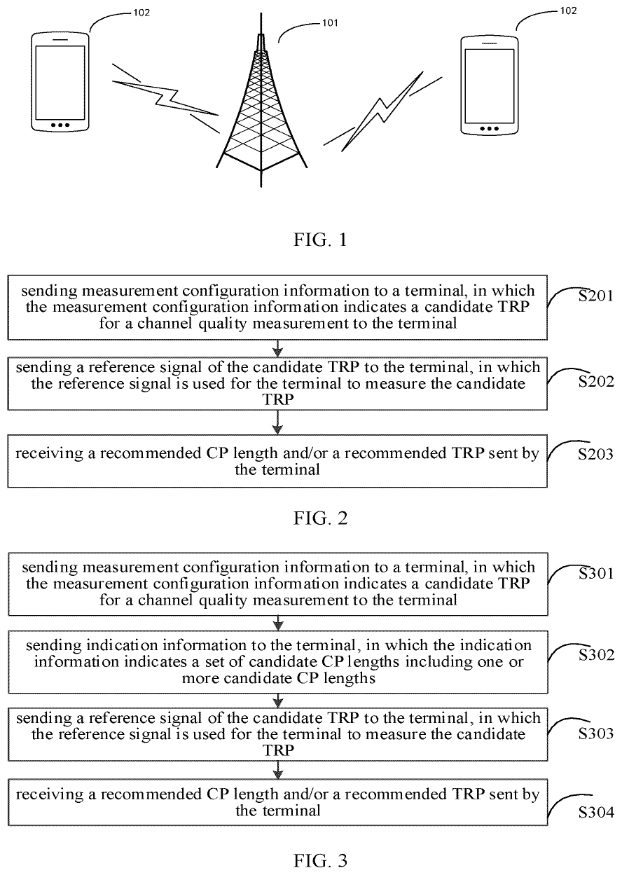

Please refer to FIG. 1, which is a schematic diagram of an architecture of a communication system according to an embodiment of the present disclosure. The communication system may include, but is not limited to, one network device and one terminal. The number and form of the devices shown in FIG. 1 are for example only and do not constitute a limitation of embodiments of the present disclosure. In practical applications, two or more network devices and two or more terminals may be included. The communication system in FIG. 1 including one network device 101 and two terminals 102 is shown as an example.

It needs to be noted that the technical solution in the embodiments of the present disclosure may be applied to various communication systems, for example, a 3th generation (3G) universal mobile telecommunication system (UMTS), a long term evolution (LTE) system, a 5th generation (5G) mobile telecommunication system, a 5G new radio (NR) system, a 6^{th} mobile telecommunication system or other new mobile telecommunication systems in the future. It should also be noted that a side link in the embodiments of the present disclosure may also be called a sidelink or a direct link.

The network device 101 in the embodiments of the present disclosure is an entity on the network side for transmitting or receiving signals. For example, the network device 101 may be an evolved NodeB (eNB), a transmission reception point (TRP), or a next generation NodeB (gNB) in the NR system, a base station in other future mobile communication systems, or an access node in wireless fidelity (WiFi) systems. The embodiments of the present disclosure do not limit the specific technology and the specific device form used by the network device. The network device in the embodiments of the present disclosure includes a CU and a DU, in which the CU may also be called a control unit. The structure of CU-DU may be used to separate protocol layers of the network device, for example, a base station, so that some of the functions of the protocol layers are centrally controlled by the CU, and the remaining part or all of the functions of the protocol layers are distributed in the DU, which is centrally controlled by the CU.

The terminal 102 in the embodiments of the present disclosure is an entity on the user side for receiving or transmitting signals, such as a mobile phone. The terminal may also be called a user equipment (UE), a mobile station (MS), a mobile terminal (MT), etc. The terminal may be a car, a smart car, a mobile phone, a wearable device, and a Pad, with communication function, a computer with wireless transceiving functions, a virtual reality (VR) terminal, an augmented reality (AR) terminal, a wireless terminal in an industrial control, a wireless terminal in a self-driving, a wireless terminal in remote medical surgery, a wireless terminal in a smart grid, a wireless terminal in a transportation safety, a wireless terminal in a smart city, a wireless terminal in a smart home, etc. The embodiments of the present disclosure do not limit the specific technology and the specific device form used by the terminal.

It may be understood that the communication system in the embodiments of the present disclosure is to more clearly explain the technical solutions of embodiments of the present disclosure, and does not constitute a limitation on the technical solutions in embodiments of the present disclosure. Those skilled in the art know that with the evolution of the system architecture and the emergence of new service scenarios, the technical solutions according to the embodiments of the present disclosure are equally applicable to similar technical problems.

It needs to be noted that the method for reporting information provided by any embodiment of the present disclosure may be executed alone, or in combination with a possible implementation in other embodiments, or in combination with any one of the technical solutions in the related art.

The method and the apparatus for reporting information in the embodiments of the present disclosure are described in detail in combination with the accompanying drawings.

Please refer to FIG. 2, which is a flowchart of a method for reporting information according to an embodiment of the present disclosure. The method for reporting information is performed by a network device, and the method includes but is not limited to S201 to S203.

At S201, measurement configuration information is sent to a terminal, in which the measurement configuration information indicates a candidate TRP for a channel quality measurement to the terminal.

In some possible implementations, the measurement configuration information indicates the candidate TRP and measurement information of the candidate TRP to the terminal, in which the measurement information of the candidate TRP indicates the terminal to measure a channel quality of the candidate TRP via the measurement information.

In some implementations, the network device may send the measurement configuration information to the terminal via control signaling. Optionally, the network device may send the measurement configuration information to the terminal via radio resource control (RRC); or, the network device may send the measurement configuration information to the terminal via a media access control control element (MAC CE); or, the network device may send the measurement configuration information to the terminal via downlink control information (DCI). The network device may also send the measurement configuration information to the terminal via other signaling.

In some implementations, the measurement configuration information includes at least one of:
identification information of the candidate TRP;
identification information of the reference signal of the candidate TRP;
a time-frequency resource location occupied by the reference signal of the candidate TRP;
a sequence of the reference signal of the candidate TRP; or
a measurement quantity and a measurement parameter of the candidate TRP.

In some embodiments, the network device may configure a set of candidate TRPs for the terminal via the measurement configuration information. The set of candidate TRPs includes one or more candidate TRPs, and the identification information of the candidate TRPs in the set of candidate TRPs may be configured to the terminal via the measurement configuration information.

In some implementations, the measurement configuration information may indicate the candidate TRP and the measurement information of the candidate TRP to the terminal. The measurement configuration information indicates the terminal to measure the candidate TRP configured by the network device for the terminal by using the measurement information corresponding to the candidate TRP, so that the terminal may select the appropriate TRP for transmission from the configured candidate TRPs. Optionally, the network device may configure all TRPs as the candidate TRPs to the terminal, or select and configure some of the all TRPs as the candidate TRPs to the terminal.

In some implementations, the measurement information of the candidate TRP may include the reference signal corresponding to the candidate TRP, that is, in order to measure a signal quality of the candidate TRP, the network device may configure one reference signal for each candidate TRP. Optionally, a same reference signal may be configured for each candidate TRP, or different reference signals may be configured for different candidate TRPs. The network device may carry the identification information of the reference signal of the candidate TRP in the measurement configuration information. Optionally, in order to enable the terminal to determine the reference signal corresponding to each candidate TRP, a correspondence relationship between the candidate TRP and its corresponding reference signal may be set, and the reference signal corresponding to the candidate TRP may be determined based on the correspondence relationship. For example, the candidate TRP may be associated with its corresponding reference information so that only one of the candidate TRP or the measurement information of the candidate TRP needs to be configured in the measurement configuration information.

In some implementations, the correspondence relationship between the candidate TRP and its corresponding reference signal may be pre-configured or specified by an agreement, and the network device may configure the candidate TRP (for example, the identification information of the candidate TRP) to the terminal via the measurement configuration information, and the terminal may determine the reference signal corresponding to the candidate TRP based on a pre-configured or agreed correspondence relationship.

In some implementations, the measurement information of the candidate TRP may include a time-frequency resource location of the reference signal of the candidate TRP, that is, the network device may configure one time-frequency resource location for the reference signal of each candidate TRP, and send the reference signal of the candidate TRP to the terminal at the time-frequency resource location. The network device may indicate the time-frequency resource location of the reference information of the candidate TRP to the terminal via the measurement configuration information. Accordingly, the terminal may receive the reference signal sent by the network device at the time-frequency resource location.

In some implementations, the measurement information of the candidate TRP may include the sequence of the reference signal of the candidate TRP, that is, sequences of reference signals corresponding to candidate TRPs are different. Because the sequence of the reference signal may be very long, in order to save a resource of transmitting the sequence of the reference signal, a sequence identifier may be created for the sequence of the reference signal of each candidate TRP, and the network device may send the sequence identifier of the sequence of the reference signal to the terminal via the measurement configuration information.

In some implementations, the measurement information of the candidate TRP may include at least one of the measurement quantity or the measurement parameter of the candidate TRP.

In some implementations, the measurement quantity may include at least one of a signal to interference plus noise ratio (SINR), a reference signal receiving power (RSRP), a reference signal receiving quality (RSRQ), or a received signal strength indication (RSSI). In some implementations, the measurement parameter may include a signal quality threshold, for example, a specified threshold corresponding to a measurement quantity. Taking the RSRP as an example, the signal quality threshold is a threshold corresponding to the measurement parameter RSRP, such as a minimum RSRP value that a signal quality of the reference signal of the candidate TRP received at the terminal needs to meet. For example, the minimum RSRP value may be −100dBm, and the minimum RSRP value is a threshold corresponding to the RSRP.

At S202, a reference signal of the candidate TRP is sent to the terminal, in which the reference signal is used for the terminal to measure the candidate TRP.

In all embodiments of the present disclosure, the measurement configuration information and the reference signal of the candidate TRP may be sent to the terminal together or separately.

In order to measure the signal quality of the candidate TRP, the network device may configure the reference signal for each candidate TRP and send the reference signal to the terminal via the candidate TRP. In some implementations, the network device may, based on the measurement configuration information, determine the time-frequency resource location of the reference signal of each candidate TRP, and send the reference signal of the candidate TRP to the terminal at the time-frequency resource location.

The terminal may receive the reference signal of each candidate TRP based on the measurement configuration information, and in response to receiving the reference signal of the candidate TRP, the terminal may process the reference signal to obtain a corresponding measurement result. The measurement result may reflect the signal quality of the candidate TRP.

At S203, a recommended CP length and/or a recommended TRP sent by the terminal is received.

The terminal may measure the signal quality of the candidate TRP according to the reference signal of the candidate TRP, to obtain the measurement result of the candidate TRP. Optionally, the measurement result of the candidate TRP may include the measurement quantity and/or an arrival time that the reference signal of the candidate TRP arrives the terminal.

In the embodiments of the present disclosure, the terminal may determine at least one of an appropriate recommended TRP or an appropriate recommended CP length from the candidate TRPs based on the measurement results of the candidate TRPs. After the terminal determines the appropriate recommended TRP and/or the recommended CP length, the terminal may report the recommended CP length and/or the recommended TRP to the network device. Accordingly, the network device may receive the recommended TRP and/or the recommended CP length reported by the terminal.

In some implementations, the recommended TRP may be one or more candidate TRPs.

In some implementations, the terminal may report the recommended TRP and the recommended CP length to the network device after determining the appropriate recommended TRP and the recommended CP length.

In some implementations, the terminal may determine the recommended TRP from the candidate TRPs based on the measurement results of the candidate TRPs, for example, the candidate TRP whose signal quality satisfies a requirement may be selected as the recommended TRP. Further, the terminal may determine an appropriate recommended CP length according to the measurement results of the candidate TRPs, for example, the appropriate recommended CP length may be determined based on the recommended TRP. The recommended CP length needs to satisfy a requirement that an arrival time that the reference signal of each recommended TRP arrives the terminal is within a time range corresponding to the recommended CP length, so as to cover different multipath delays of the recommended TRPs.

In some implementations, the terminal may select a candidate CP length from candidate CP lengths as the recommended CP length according to a certain rule. For example, the recommended CP length may be one candidate CP length in a set of candidate CP lengths for the terminal. Optionally, the set of candidate CP lengths may be specified by an agreement, or configured or indicated by a network. The set of candidate CP lengths includes one or more candidate CP lengths. Optionally, the recommended CP length may be a CP length selected from the set of candidate CP lengths according to a set rule; for example, a minimum CP length may be selected as the recommended CP length.

Further, according to the measurement result of the candidate TRP, the candidate TRP whose signal quality satisfies the requirement and whose reference signal has an arrival time within the time range corresponding to the recommended CP length may be selected as the recommended TRP.

It needs to be noted that it is possible to determine whether the candidate TRP satisfies a signal quality condition based on the measurement quantity and the measurement parameter of the candidate TRP. For example, in a case where the measurement quantity configured by the network device is the RSRP, if an RSRP value of the reference signal of the candidate TRP is greater than an RSRP threshold, the candidate TRP may be determined as the recommended TRP that satisfies the signal quality condition. For another example, the measurement quantity configured by the network device includes the RSRP and the RSRQ. If an RSRP value of the reference signal of the candidate TRP is greater than the RSRP threshold, and an RSRQ value of the reference signal is greater than an RSRQ threshold, the candidate TRP may be determined as the recommended TRP that satisfies the signal quality condition. That is, when the network device configures a plurality of measurement quantities, each measurement quantity of the candidate TRP needs to satisfy a threshold requirement.

In the embodiments of the present disclosure, the network device determines the measurement configuration information of the candidate TRP, sends the measurement configuration information to the terminal, and sends the reference signal of the candidate TRP to the terminal, so that the terminal may measure the signal quality of the candidate TRP based on the reference signal. The terminal may determine the recommended CP length and/or the recommended TRP based on the measurement result of the candidate TRP, and the network device receives the recommended CP length and/or the recommended TRP reported by the terminal. In the embodiments of the present disclosure, the appropriate CP length and the appropriate TRP are determined based on the measurement result, in which the appropriate CP length may guarantee coverage over a multipath delay of the selected TRP, and the appropriate TRP may make the signal quality of the terminal better and improve stability of communication between the network device and the terminal.

Please refer to FIG. 3, which is a flowchart of a method for reporting information according to an embodiment of the present disclosure. The method for reporting information is performed by a network device, and the method includes but is not limited to S301 to S304.

At S301, measurement configuration information is sent to a terminal, in which the measurement configuration information indicates a candidate TRP for a channel quality measurement to the terminal.

For a detailed description of S301, please refer to relevant content in the above embodiments such as S201, which is not repeated herein.

At S302, indication information is sent to the terminal, in which the indication information indicates a set of candidate CP lengths including one or more candidate CP lengths.

The set of candidate CP lengths={CP₁, CP₂, CP₃ . . . } , in which CPᵢ represents a candidate CP length. Optionally, a value of the CP length may include a previously supported CP length or a newly added CP length defined later. For example, the value of the CP length may be 4.687 us, 16.67 us, or 33.33 us.

In all embodiments of the present disclosure, the measurement configuration information and the indication information may be sent to the terminal together or separately.

In some implementations, the network device may determine an index value of the set of candidate CP lengths and send the index value to the terminal as the indication information. After obtaining the index value of the set of candidate CP lengths, the terminal may determine a corresponding set of candidate CP lengths according to the index value, and then obtain one or more candidate CP lengths included in the set of candidate CP lengths.

In some implementations, the network device may also directly indicate the candidate CP length in the set of candidate CP lengths to the terminal.

In some implementations, the network device may also indicate a type of the candidate CP length in the set of candidate CP lengths to the terminal. Optionally, the type of the candidate CP length may include a normal cyclic prefix (CP), an extended CP, or other new types.

In some implementations, the network device may send information relevant to the above set of the candidate CP lengths to the terminal via broadcast signaling or dedicated signaling.

At S303, a reference signal of the candidate TRP is sent to the terminal, in which the reference signal is used for the terminal to measure the candidate TRP.

For a detailed description of S303, please refer to relevant content in the above embodiments such as S202, which is not repeated herein.

At S304, a recommended CP length and/or a recommended TRP sent by the terminal are received.

In some implementations, the recommended CP length may be one CP length in the set of candidate CP lengths corresponding to the terminal. For example, the recommended CP length may be the minimum CP length in the set of candidate CP lengths.

In some implementations, the recommended TRP may be one or more candidate TRPs.

In some implementations, the terminal may report the recommended TRP and the recommended CP length to the network device after determining the appropriate recommended TRP and the recommended CP length.

In some implementations, the network device may receive an index value of the recommended CP length reported by the terminal and determine the recommended CP length based on the index value of the recommended CP length.

In some implementations, the network device may receive identification information of the recommended TRP reported by the terminal. Optionally, the network device may also receive a measurement result of the recommended TRP reported by the terminal.

In some implementations, the network device may obtain the index value of the recommended CP length and the identification information of the recommended TRP and/or the measurement result of the recommended TRP in one piece of reported information.

In some implementations, the network device may obtain the index value of the recommended CP length in one piece of reported information and obtain the identification information of the recommended TRP and/or the measurement result of the recommended TRP in another piece of reported information.

For a detailed description of S304, please refer to relevant content in the above embodiments such as S203, which is not repeated herein.

In the embodiment of the present disclosure, the network device sends the measurement configuration information to the terminal and sends the reference signal of the candidate TRP to the terminal, so that the terminal may measure the signal quality of the candidate TRP based on the reference signal. The terminal may determine the recommended CP length and/or the recommended TRP according to the measurement result of the candidate TRP. The network device receives the recommended CP length and/or the recommended TRP reported by the terminal. In the embodiments of the present disclosure, the appropriate CP length and the appropriate TRP are determined based on the measurement result, in which the appropriate CP length may guarantee coverage over a multipath delay of the selected TRP, and the appropriate TRP may make the signal quality of the terminal better and improve stability of communication between the network device and the terminal.

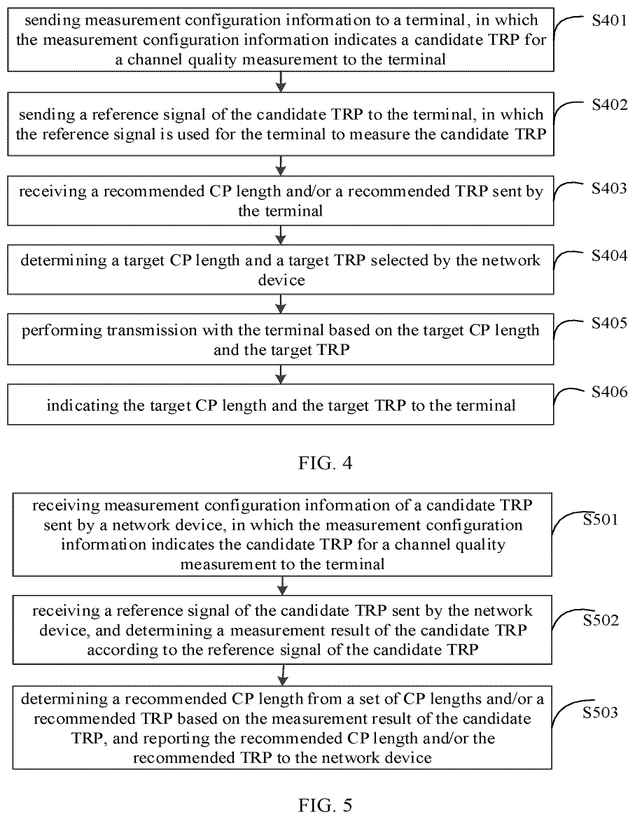

Please refer to FIG. 4, which is a flowchart of a method for reporting information according to an embodiment of the present disclosure. The method for reporting information is performed by a network device, and the method includes but is not limited to S401 to S406.

At S401, measurement configuration information is sent to a terminal, in which the measurement configuration information indicates a candidate TRP for a channel quality measurement to the terminal.

At S402, a reference signal of a candidate TRP is sent to the terminal, in which the reference signal is used for the terminal to measure the candidate TRP.

In all embodiments of the present disclosure, the measurement configuration information and the reference signal of the candidate TRP may be sent to the terminal together or separately.

At S403, a recommended CP length and/or a recommended TRP sent by the terminal is received.

For a detailed description of S401 to S403, please refer to relevant content in the above embodiments such as S201 to S203, which is not repeated herein.

At S404, a target CP length and a target TRP selected by the network device are determined.

Optionally, the target CP length may be the same as or different from the recommended CP length reported by the terminal. Optionally, the target TRP may be the same as or different from the recommended TRP reported by the terminal.

In some implementations, the network device may select some of the recommended TRPs as target TRPs based on the measurement results.

In other implementations, the network device may select some of the recommended TRPs as the target TRPs based on a service situation of the terminal.

In other implementations, since there are a plurality of terminals in the communication system, the network device may select some of the recommended TRPs as the target TRPs based on the measurement results by comprehensively considering both maximization of multi-user capacity of the system and interference factors.

At S405, transmission with the terminal is performed based on the target CP length and the target TRP.

The network device may perform transmission of information and/or data with the terminal based on the target CP length and the target TRP.

At S406, the target CP length and the target TRP are indicated to the terminal.

In some implementations, the network device may indicate the target CP length and the target TRP to the terminal. Optionally, the target TRP may be one or more TRPs.

In some implementations, the network device may send an index value of the target CP length to the terminal, so that the terminal may determine the target CP length based on the index value. Optionally, the network device may send identification information of the target TRP to the terminal.

In some implementations, the network device may indicate the index value of the target CP length and the identification information of the target TRP to the terminal via one piece of indication information; or, the network device may indicate the index value of the target CP length to the terminal in one piece of indication information and indicate the identification information of the target TRP to the terminal in another piece of indication information.

In the embodiments of the present disclosure, the appropriate CP length and the appropriate TRP are determined based on the measurement results, in which the appropriate CP length may guarantee to cover a multipath delay of the selected TRP, and the appropriate TRP may make the signal quality of the terminal better and improve stability of communication between the network device and the terminal.

Please refer to FIG. 5, which is a flowchart of a method for reporting information according to an embodiment of the present disclosure. The method for reporting information is performed by a terminal, and the method includes but is not limited to S501 to S503.

At S501, measurement configuration information of a candidate TRP sent by a network device is received, in which the measurement configuration information indicates the candidate TRP for a channel quality measurement to the terminal.

In some implementations, the measurement configuration information indicates the candidate TRP and measurement information of the candidate TRP to the terminal, in which the measurement configuration information of the candidate TRP indicates the terminal to measure the candidate TRP via the measurement information.

In some implementations, the terminal may receive the measurement configuration information sent by the network device via control signaling. Optionally, the control signaling may be RRC, or an MAC CE, or DCI, or other signaling.

In some implementations, the measurement configuration information includes at least one of:
identification information of the candidate TRP;
identification information of the reference signal of the candidate TRP;
a time-frequency resource location occupied by the reference signal of the candidate TRP;
a sequence of the reference signal of the candidate TRP; or
a TRP measurement quantity and a measurement parameter.

In some embodiments, the network device may configure a set of candidate TRPs for the terminal via the measurement configuration information. The set of candidate TRPs includes one or more candidate TRPs, and the identification information of the candidate TRPs in the set of candidate TRPs may be configured to the terminal via the measurement configuration information.

In some implementations, the measurement configuration information may indicate the candidate TRP and the measurement information of the candidate TRP to the terminal. The measurement configuration information indicates the terminal to measure the candidate TRP configured by the network device for the terminal by using the measurement information corresponding to the candidate TRP, so that the terminal may select the appropriate TRP for transmission from the configured candidate TRPs. Optionally, the network device may configure all TRPs as the candidate TRPs to the terminal, or select and configure some of the all TRPs as the candidate TRPs to the terminal.

In some implementations, the measurement information of the candidate TRP may include the reference signal corresponding to the candidate TRP, that is, in order to measure a signal quality of the candidate TRP, the network device may configure one reference signal for each candidate TRP. Optionally, a same reference signal may be configured for each candidate TRP, or different reference signals may be configured for different candidate TRPs. The network device may carry the identification information of the reference signal of the candidate TRP in the measurement configuration information. Optionally, in order to enable the terminal to determine the reference signal corresponding to each candidate TRP, a correspondence relationship between the identification information of the candidate TRP and the identification information of its corresponding reference signal may be set, and the reference signal corresponding to the candidate TRP may be determined based on the correspondence relationship. For example, the candidate TRP may be associated with its corresponding reference information so that only one of the candidate TRP or the measurement information of the candidate TRP needs to be configured in the measurement configuration information.

In some implementations, the correspondence relationship between the candidate TRP and its corresponding reference signal may be pre-configured or specified by an agreement, and the network device may configure the candidate TRP (for example, the identification information of the candidate TRP) to the terminal via the measurement configuration information, and the terminal may determine the reference signal corresponding to the candidate TRP based on a pre-configured or agreed correspondence relationship.

In some implementations, the measurement information of the candidate TRP may include a time-frequency resource location of the reference signal of the candidate TRP, that is, the network device may configure one time-frequency resource location for the reference signal of each candidate TRP, and send the reference signal of the candidate TRP to the terminal at the time-frequency resource location. The network device may indicate the time-frequency resource location of the reference information of the candidate TRP to the terminal via the measurement configuration information. Accordingly, the terminal may receive the reference signal sent by the network device at the time-frequency resource location.

In some implementations, the measurement information of the candidate TRP may include the sequence of the reference signal of the candidate TRP, that is, sequences of reference signals corresponding to candidate TRPs are different. Because the sequence of the reference signal may be very long, in order to save a resource of transmitting the sequence of the reference signal, a sequence identifier may be set for the sequence of the reference signal of each candidate TRP, and the network device may send the sequence identifier of the sequence of the reference signal to the terminal via the measurement configuration information.

In some implementations, the measurement information of the candidate TRP may include at least one of the TRP measurement quantity or the measurement parameter.

In some implementations, the TRP measurement quantity may include at least one of an SINR, an RSRP, an RSRQ, or an RSSI. In some implementations, the measurement parameter may include a signal quality threshold, for example, a specified threshold corresponding to a measurement quantity. Taking the RSRP as an example, the signal quality threshold is a threshold corresponding to the measurement parameter RSRP, such as a minimum RSRP value that a signal quality of the reference signal of the candidate TRP received at the terminal needs to meet. For example, the minimum RSRP value may be −100dBm, and the minimum RSRP value is a threshold corresponding to the RSRP.

At S502, a reference signal of the candidate TRP sent by the network device is received, and a measurement result of the candidate TRP is determined according to the reference signal of the candidate TRP.

In order to measure the signal quality of the candidate TRP, the network device may configure the reference signal for each candidate TRP and the reference signal to the terminal via the candidate TRP. In some implementations, the terminal may, based on the measurement configuration information, determine the time-frequency resource location of the reference signal of each candidate TRP, and receive the reference signal of the candidate TRP sent by the network device at the time-frequency resource location.

The terminal may receive the reference signal of each candidate TRP based on the measurement configuration information, and in response to receiving the reference signal of the candidate TRP, the terminal may process the reference signal to obtain a corresponding measurement result. The measurement result may reflect the signal quality of the candidate TRP.

In all embodiments of the present disclosure, the measurement configuration information and the reference signal of the candidate TRP may be sent to the terminal together or separately.

At S503, a recommended CP length is determined from a set of CP lengths and/or a recommended TRP is determined based on the measurement result of the candidate TRP, and the recommended CP length and/or the recommended TRP is reported to the network device.

The terminal may measure the signal quality of the candidate TRP according to the reference signal of the candidate TRP, to obtain the measurement result of the candidate TRP. Optionally, the measurement result of the candidate TRP may include the measurement quantity and/or an arrival time that the reference signal of the candidate TRP arrives the terminal.

In the embodiments of the present disclosure, the terminal may determine at least one of an appropriate recommended TRP or an appropriate recommended CP length from the candidate TRPs based on the measurement results of the candidate TRPs. After the terminal determines the appropriate recommended TRP and/or the recommended CP length, the terminal may report the recommended CP length and/or the recommended TRP to the network device. Accordingly, the network device may receive the recommended TRP and/or the recommended CP length reported by the terminal.

In some implementations, the recommended TRP may be one or more candidate TRPs.

In some implementations, the terminal may report the recommended TRP and the recommended CP length to the network device after determining the appropriate recommended TRP and the recommended CP length.

In some implementations, the terminal may determine the recommended TRP from the candidate TRPs based on the measurement result of the candidate TRP, for example, the candidate TRP whose signal quality satisfies a requirement may be selected as the recommended TRP. Further, the terminal may determine an appropriate recommended CP length according to the measurement result of the candidate TRP, for example, the appropriate recommended CP length may be determined based on the recommended TRP. The recommended CP length needs to satisfy a requirement that an arrival time that the reference signal of each recommended TRP arrives the terminal is within a time range corresponding to the recommended CP length, so as to cover different multipath delays of the recommended TRPs.

In some implementations, the terminal may select a candidate CP length from candidate CP lengths as the recommended CP length according to a certain rule, for example, the recommended CP length may be one candidate CP length in a set of candidate CP lengths for the terminal. Optionally, the set of candidate CP lengths may be specified by an agreement, or configured or indicated by a network. The set of candidate CP lengths includes one or more candidate CP lengths. Optionally, the recommended CP length may be a CP length selected from the set of candidate CP lengths according to a set rule; for example, a minimum CP length may be selected as the recommended CP length.

Further, according to the measurement result of the candidate TRP, the candidate TRP whose signal quality satisfies the requirement and whose reference signal has an arrival time within the time range corresponding to the recommended CP length may be selected as the recommended TRP.

It needs to be noted that it is possible to determine whether the candidate TRP satisfies a signal quality condition based on the measurement quantity and the measurement parameter of the candidate TRP. For example, in a case where the measurement quantity configured by the network device is the RSRP, if an RSRP value of the reference signal of the candidate TRP is greater than an RSRP threshold, the candidate TRP may be determined as the recommended TRP that satisfies the signal quality condition. For another example, the measurement quantity configured by the network device includes the RSRP and the RSRQ. If an RSRP value of the reference signal of the candidate TRP is greater than the RSRP threshold, and an RSRQ value of the reference signal is greater than an RSRQ threshold, the candidate TRP may be determined as the recommended TRP that satisfies the signal quality condition. That is, when the network device configures a plurality of measurement quantities, each measurement quantity of the candidate TRP needs to satisfy a threshold requirement.

In the embodiments of the present disclosure, the terminal receives the measurement configuration information of the candidate TRP and the reference signal of the candidate TRP, measures the signal quality of the candidate TRP based on the reference signal, determines the recommended CP length and/or the recommended TRP based on the measurement result of the candidate TRP, and the network device receives the recommended CP length and/or the recommended TRP reported by the terminal. In the embodiments of the present disclosure, the appropriate CP length and the appropriate TRP are determined based on the measurement result, in which the appropriate CP length may guarantee to cover a multipath delay of the selected TRP, and the appropriate TRP may make the signal quality of the terminal better and improve stability of communication between the network device and the terminal.

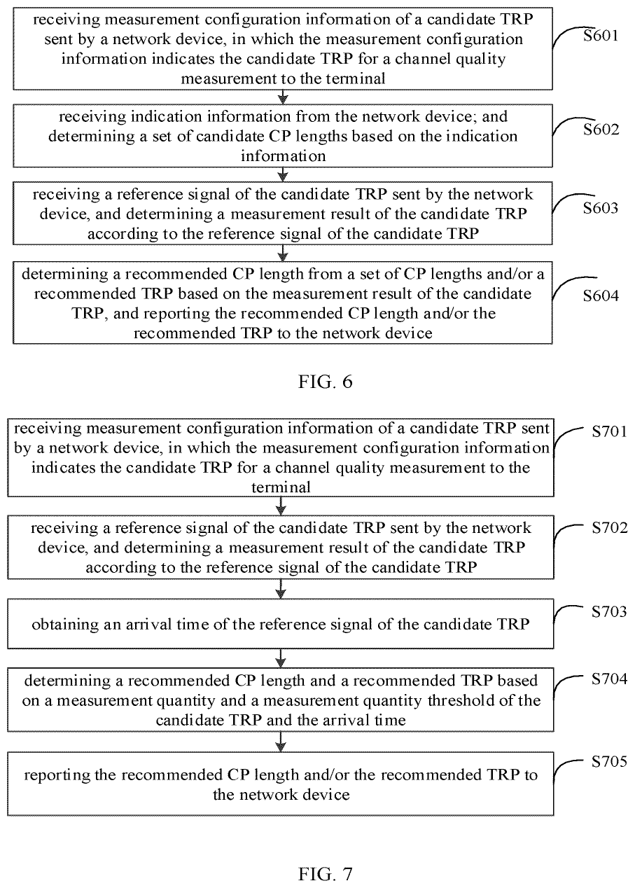

Please refer to FIG. 6, which is a flowchart of a method for reporting information according to an embodiment of the present disclosure. The method for reporting information is performed by a terminal, and the method includes but is not limited to S601 to S604.

At S601, measurement configuration information of a candidate TRP sent by a network device is received, in which the measurement configuration information indicates the candidate TRP for a channel quality measurement to the terminal.

For a detailed description of S601, please refer to relevant content in the above embodiments such as S501, which is not repeated herein.

At S602, indication information from the network device is received; and a set of candidate CP lengths is determined based on the indication information.

In all embodiments of the present disclosure, the measurement configuration information and the indication information may be sent to the terminal together or separately.

The set of candidate CP lengths includes one or more candidate CP lengths.

The set of candidate CP lengths={CP₁, CP₂, CP₃ . . . } , in which CPᵢ represents a candidate CP length. Optionally, a value of the CP length may include a previously supported CP length or a newly added CP length defined later. For example, the value of the CP length may be 4.687 us, 16.67 us, or 33.33 us.

In some implementations, the network device may determine an index value of the set of candidate CP lengths, and the terminal may receive the index value of the set of candidate CP lengths sent by the network device, determine a corresponding set of candidate CP lengths according to the index value, and then obtain one or more candidate CP lengths included in the set of candidate CP lengths.

In some implementations, the terminal may receive the candidate CP length in the set of candidate CP lengths directly indicated by the network device.

In some implementations, the terminal may also receive a type of the candidate CP length in the set of candidate CP lengths indicated by the network device. Optionally, the type of the candidate CP length may include a normal CP, an extended CP, or other new types.

In some implementations, the terminal may receive information relevant to the above set of the candidate CP lengths from the network device via broadcast signaling or dedicated signaling.

At S603, a reference signal of the candidate TRP sent by the network device is received, and a measurement result of the candidate TRP is determined according to the reference signal of the candidate TRP.

For a detailed description of S603, please refer to relevant content in the above embodiments such as S502, which is not repeated herein.

At S604, a recommended CP length is determined from the set of CP lengths and/or a recommended TRP is determined based on the measurement result of the candidate TRP, and the recommended CP length and/or the recommended TRP is reported to the network device.

In some implementations, the recommended CP length may be one CP length in the set of candidate CP lengths corresponding to the terminal. For example, the recommended CP length may be a minimum CP length in the set of candidate CP lengths.

In some implementations, the recommended TRP may be one or more candidate TRPs.

In some implementations, the terminal may report the recommended TRP and the recommended CP length to the network device after determining the appropriate recommended TRP and the recommended CP length.

In some implementations, the terminal may report an index value of the recommended CP length to the network device and the network device may determine the recommended CP length based on the index value of the recommended CP length.

In some implementations, the terminal may report identification information of the recommended TRP to the network device. Optionally, the terminal may report the measurement result of the recommended TRP to the network device. Optionally, the terminal may directly report a measurement quantity of the recommended TRP to the network device. Optionally, the terminal may report a difference between the measurement quantity and a measurement parameter (a threshold of the measurement quantity) of the recommended TRP to the network device. For example, when an RSRP value of the reference signal of the recommended TRP received at the terminal is −70 dBm, the terminal may directly report −70 dBm. For another example, when the RSRP value of the reference signal of the recommended TRP received at the terminal is −70 dBm and a corresponding threshold of the RSRP is −80 dBm, the terminal may report 10 dBm, that is, the difference between the RSRP value of the recommended TRP and the RSRP threshold.

In some implementations, the terminal may report the index value of the recommended CP length, the identification information of the recommended TRP, and/or the measurement result of the recommended TRP via one piece of reported information. In other implementations, the terminal may report the index value of the recommended CP length via one piece of reported information, and report the identification information of the recommended TRP and/or the measurement result of the recommended TRP via another piece of reported information.

For a detailed description of S604, please refer to relevant content in the above embodiments such as S503, which is not repeated herein.

In the embodiments of the present disclosure, the terminal may measure the signal quality of the candidate TRP based on the measurement configuration information and the reference signal of the candidate TRP, and determine the appropriate CP length and the appropriate TRP based on the measurement result, in which the appropriate CP length may guarantee to cover a multipath delay of the selected TRP, and the appropriate TRP may make the signal quality of the terminal better and improve stability of communication between the network device and the terminal.

Please refer to FIG. 7, which is a flowchart of a method for reporting information according to an embodiment of the present disclosure. The method for reporting information is performed by a terminal, and the method includes but is not limited to S701 to S705.

At S701, measurement configuration information of a candidate TRP sent by a network device is received, in which the measurement configuration information indicates the candidate TRP for a channel quality measurement to the terminal.

At S702, a reference signal of the candidate TRP sent by the network device is received, and a measurement result of the candidate TRP is determined according to the reference signal of the candidate TRP.

For a detailed description of S701 to S702, please refer to relevant content in the above embodiments such as S502, which is not repeated herein.

In all embodiments of the present disclosure, the measurement configuration information and the reference signal of the candidate TRP may be sent to the terminal together or separately.

At S703, an arrival time of the reference signal of the candidate TRP is obtained.

The terminal may receive the reference signal of the candidate TRP based on the measurement configuration information, and determine the time when the reference signal of the candidate TRP is received as the arrival time of the reference signal of the candidate TRP.

At S704, a recommended CP length and a recommended TRP are determined based on a measurement quantity and a measurement quantity threshold of the candidate TRP and the arrival time.

As a possible implementation, the terminal may determine a set of recommended TRPs by selecting a first candidate TRP that satisfies a signal quality condition from a set of candidate TRPs according to the measurement quantity and the measurement parameter of the candidate TRP. It needs to be noted that the first candidate TRP in the set of recommended TRPs is the recommended TRP. For a detailed description of determining whether the candidate TRP satisfies the signal quality condition according to the measurement quantity and the measurement parameter of the candidate TRP, please refer to relevant content in the above embodiments, which is not repeated herein.

Further, the terminal may determine a required reference CP length according to an arrival time of a reference signal of the first candidate TRP in the set of recommended TRPs. Further, the terminal may determine the recommended CP length from the set of candidate CP lengths of the terminal based on the reference CP length. The set of candidate CP lengths may be a set configured by the network device or specified in an agreement. For a detailed description of the set of candidate CP lengths, please refer to relevant content in the above embodiments, which is not repeated herein.

In some implementations, the terminal may determine a TRP reporting number of TRPs that the terminal may report based on a network indication or an agreement. Further, the terminal may obtain the set of recommended TRPs by selecting a same number of TRPs as the TRP reporting number from the first candidate TRPs based on the TRP reporting number. Optionally, the first candidate TRPs may be sorted according to the measurement quantity, and the set of recommended TRPs may be obtained by selecting TRPs whose number is the same as the TRP reporting number according to a descending order of the measurement quantity.

In other implementations, the terminal may determine a TRP demanding number according to its own service types, and obtain the set of recommended TRPs by selecting the same number of TRPs as the TRP demanding number from the first candidate TRPs according to the TRP demanding number. Optionally, the first candidate TRPs may be sorted according to the measurement quantity, and the set of recommended TRPs may be obtained by selecting TRPs whose number is the same as the TRP demanding number according to a descending order of the measurement quantity.

It needs to be noted that under a constraint of the TRP reporting number or the TRP demanding number, there are a minimum number of first candidate TRPs included in the set of recommended TRPs. The first candidate TRPs included in the set of recommended TRPs are the recommended TRPs determined by the terminal.

In the embodiments of the present disclosure, a process of the terminal determining the reference CP length may be described as follows. The terminal may obtain arrival times of reference signals of all first candidate TRPs on each path, compare all the arrival times, determine an earliest arrival time and a latest arrival time from all the arrival times. Further, the terminal may determine a difference between the latest arrival time and the earliest arrival time as a required reference CP length.

In some implementations, the terminal may determine, from the set of candidate CP lengths, a candidate CP length that is greater than the reference CP length and has a smallest difference with the reference CP length, as the recommended CP length. For example, if the reference CP length is 3.43 us, and the set of candidate CP lengths is {3 us, 3.5 us, 4 us, 4.5 us . . . } , the terminal may determine a candidate CP length that is closest to 3.43 us and greater than 3.43 us from the set of candidate CP lengths as 3.5 us, and determine 3.5 us as the recommended CP length.

In the embodiments of the present disclosure, the reference CP length is determined based on the difference between the earliest arrival time and the latest arrival time of the reference signal of the recommended TRP, so that the recommended TRP may fall within a time range covered by the reference CP length. Since the recommended CP length is greater than the reference CP length, correspondingly, the reference signal of the recommended TRP may also fall within the time range covered by the recommended CP length to ensure that the recommended CP length may cover the multipath delay of each recommended TRP.

As another possible implementation, the terminal may determine a minimum CP length in a set of candidate CP lengths; select one or more second candidate TRPs that satisfy a signal quality condition from a set of candidate TRPs based on the measurement quantity and the measurement parameter of the candidate TRP; select a third candidate TRP from one or more second candidate TRPs, in which an arrival time of a reference signal of the third candidate TRP falls within a time range of the minimum CP length; and determine the third candidate TRP as the recommended TRP, in which the minimum CP length is the recommended CP length.

At S705, the recommended CP length and/or the recommended TRP is reported to the network device.

For a detailed description of S705, please refer to relevant content in the above embodiments such as S503 and S604, which is not repeated herein.

In the embodiments of the present disclosure, the terminal may measure the signal quality of the candidate TRP based on the measurement configuration information and the reference signal of the candidate TRP, and determine the appropriate CP length and the appropriate TRP based on the measurement result, in which the appropriate CP length may guarantee to cover a multipath delay of the selected TRP, and the appropriate TRP may make the signal quality of the terminal better and improve stability of communication between the network device and the terminal.

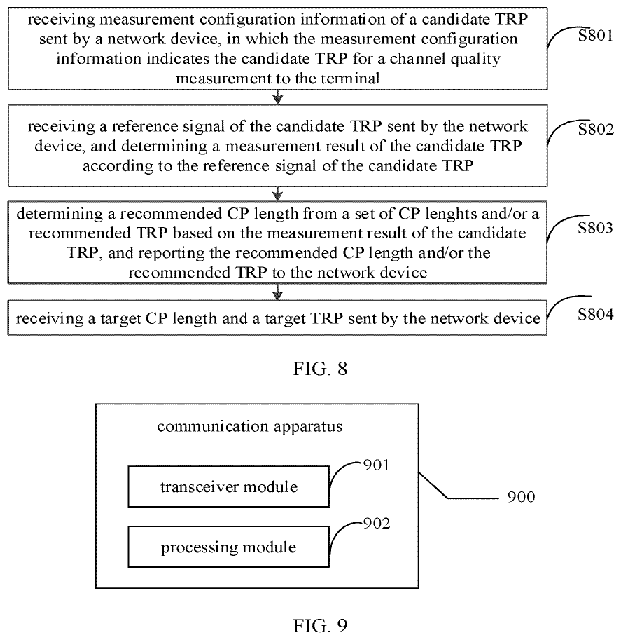

Please refer to FIG. 8, which is a flowchart of a method for reporting information according to an embodiment of the present disclosure. The method for reporting information is performed by a terminal, and the method includes but is not limited to S801 to S804.

At S801, measurement configuration information of a candidate TRP sent by a network device is received, in which the measurement configuration information indicates the candidate TRP for a channel quality measurement to the terminal.

At S802, a reference signal of the candidate TRP sent by the network device is received, and a measurement result of the candidate TRP is determined according to the reference signal of the candidate TRP.

In all embodiments of the present disclosure, the measurement configuration information and the reference signal of the candidate TRP may be sent to the terminal together or separately.

At S803, a recommended CP length is determined from a set of CP lengths and/or a recommended TRP is determined based on the measurement result of the candidate TRP, and the recommended CP length and/or the recommended TRP is reported to the network device.

For a detailed description of S801 to S803, please refer to relevant content in the above embodiments, which is not repeated herein.

At S804, a target CP length and a target TRP sent by the network device are received.

Optionally, the target CP length may be the same as or different from the recommended CP length reported by the terminal. Optionally, the target TRP may be the same as or different from the recommended TRP reported by the terminal.

In some implementations, the network device may select some of the recommended TRPs as target TRPs based on the measurement results. In other implementations, the network device may select some of the recommended TRPs as the target TRPs based on a service situation of the terminal. In other implementations, since there are a plurality of terminals in the communication system, the network device may select some of the recommended TRPs as the target TRPs based on the measurement results by comprehensively considering both maximization of multi-user capacity of the system and interference factors. The network device may perform transmission of information and/or data with the terminal based on the target CP length and the target TRP.

In some implementations, the terminal may receive the target CP length and the target TRP indicated by the network device. Optionally, the target TRP may be one or more TRPs. Optionally, the terminal may receive an index value of the target CP length sent by the network device and determine the target CP length based on the index value. Optionally, the terminal may receive identification information of the target TRP sent by the network device.

In some implementations, the terminal may receive the index value of the target CP length indicated by the network device and the identification information of the target TRP in one piece of indication information; or the terminal may receive the index value of the target CP length in one piece of indication information and the identification information of the target TRP in another piece of indication information.

In the embodiments of the present disclosure, the terminal may measure a signal quality of the candidate TRP based on the measurement configuration information and the reference signal of the candidate TRP, and determine the appropriate CP length and the appropriate TRP based on the measurement result, in which the appropriate CP length may guarantee to cover a multipath delay of the selected TRP, and the appropriate TRP may make the signal quality of the terminal better and improve stability of communication between the network device and the terminal.

In the embodiments provided by the present disclosure, the method in the embodiments of the present disclosure is described from perspectives of both the network device and the terminal. To perform functions provided in the above embodiments, the network device and the first terminal may include a hardware structure and a software module, and realize the above functions with the hardware structure, the software module, or a combination of the hardware structure and the software module. A specific function may be performed as the hardware structure, the software module, or the hardware structure plus the software module.

Please refer to FIG. 9, which is a block diagram of a communication apparatus 900 according to an embodiment of the present disclosure. The communication apparatus 900 shown in FIG. 9 may include a transceiver module 901 and a processing module 902. The transceiver module 901 may include a sending module and/or a receiving module, in which the sending module is used to achieve the sending function, and the receiving module is used to achieve the receiving function. The transceiver module 901 may achieve the sending function and/or the receiving function.

The communication apparatus 900 may be a terminal, an apparatus in a terminal, or an apparatus capable of being used in combination with a terminal. Or, the communication apparatus 900 may be a network device, an apparatus in a network device, or an apparatus capable of being used in combination with a network device.

The communication apparatus 900 may be a terminal, including:

a transceiver module 901, configured to send measurement configuration information to a terminal, in which the measurement configuration information indicates a candidate TRP for a channel quality measurement to the terminal; send a reference signal of the candidate TRP to the terminal, in which the reference signal is used for the terminal to measure the candidate TRP; and receive a recommended CP length and/or a recommended TRP sent by the terminal, in which the recommended CP length and/or the recommended TRP is determined by the terminal based on a measurement result of the candidate TRP.

In some implementations, the recommended CP length is one CP length in a set of candidate CP lengths for the terminal, and the recommended TRP is one or more candidate TRPs.

In some implementations, the measurement configuration information includes at least one of:
identification information of the candidate TRP;
identification information of the reference signal of the candidate TRP;
a time-frequency resource location occupied by the reference signal of the candidate TRP;
a sequence of reference signals of the candidate TRP; or
a measurement quantity and a measurement parameter of the candidate TRP.

In some implementations, the transceiver module 901 is further configured to send indication information to the terminal, in which the indication information indicates a set of candidate CP lengths including one or more candidate CP lengths.

In some implementations, the transceiver module 901 is further configured to determine an index value of the set of candidate CP lengths; and
send the index value to the terminal as the indication information.

In some implementations, the transceiver module 901 is further configured to receive the identification information of the recommended TRP and/or a measurement result of the recommended TRP sent by the terminal.

In some implementations, the processing module 902 is configured to determine a target CP length and a target TRP selected by the network device, in which a target CP length is the same as or different from the recommended CP length, and the target TRP is the same as or different from the recommended TRP; perform transmission with the terminal based on the target CP length and the target TRP.

In some implementations, the transceiver module 901 is further configured to indicate the target CP length and the target TRP to the terminal.

The communication apparatus 900 may be a terminal, including:
a transceiver module 901, configured to receive measurement configuration information of a candidate TRP sent by a network device, in which the measurement configuration information indicates the candidate TRP for a channel quality measurement to the terminal; receive a reference signal of the candidate TRP sent by the network device, and report a recommended CP length and a recommended TRP to the network device; and
a processing module 902, configured to determine a measurement result of the candidate TRP according to the reference signal of the candidate TRP; and determine the recommended CP length and the recommended TRP based on the measurement result of the candidate TRP.

In some implementations, the recommended CP length is one CP length in a set of candidate CP lengths for the terminal, and the recommended TRP is one or more candidate TRPs.

In some implementations, the measurement configuration information includes at least one of:
identification information of the candidate TRP;
identification information of the reference signal of the candidate TRP;
a time-frequency resource location occupied by the reference signal of the candidate TRP;
a sequence of reference signals of the candidate TRP; or
a measurement quantity and a measurement parameter of the candidate TRP.

In some implementations, the processing module 902 is further configured to obtain an arrival time of the reference signal of the candidate TRP; and
determine the recommended CP length and the recommended TRP based on the measurement quantity and the measurement parameter of the candidate TRP and the arrival time.

In some implementations, the processing module 902 is further configured to determine a set of recommended TRPs by selecting a first candidate TRP that satisfies a quality condition from a set of candidate TRPs according to the measurement quantity and the measurement parameter of the candidate TRP, in which there are a minimum number of first candidate TRPs included in the set of recommended TRPs, and the first candidate TRP is the recommended TRP; determine a reference CP length according to an arrival time of a reference signal of the first candidate TRP; and determine the recommended CP length from a set of candidate CP lengths of the terminal based on the reference CP length.

In some implementations, the processing module 902 is further configured to determine an earliest arrival time and a latest arrival time from arrival times of reference signals of all first candidate TRPs; and determine a difference between the latest arrival time and the earliest arrival time as the reference CP length.

In some implementations, the processing module 902 is further configured to determine, from the set of candidate CP lengths of the terminal, a candidate CP length that is greater than the reference CP length and has a smallest difference with the reference CP length, as the recommended CP length.

In some implementations, the processing module 902 is further configured to determine a minimum CP length in a set of candidate CP lengths of the terminal; select a second candidate TRP that satisfies a signal quality condition from a set of candidate TRPs based on the measurement quantity and the measurement parameter of the candidate TRP; select a third candidate TRP from second candidate TRPs, in which an arrival time of a reference signal of the third candidate TRP falls within a time range of the minimum CP length; and determine the third candidate TRP as the recommended TRP and the minimum CP length as the recommended CP length.

In some implementations, the transceiver module 901 is further configured to receive indication information from the network device; and
the processing module 902 is further configured to determine the set of candidate CP lengths based on the indication information, in which the set of candidate CP lengths includes one or more candidate CP lengths.

In some implementations, the transceiver module 901 is further configured to receive an index value of the set of candidate CP lengths sent by the network device; and
the processing module 902 is further configured to determine the set of candidate CP lengths based on the index value.

In some implementations, the transceiver module 901 is further configured to report identification information of the recommended TRP and/or a measurement result of the recommended TRP to the network device.

In some implementations, the transceiver module 901 is further configured to directly report a measurement quantity of the recommended TRP to the network device; or report a difference between the measurement quantity and a measurement parameter of the recommended TRP to the network device.

In some implementations, the transceiver module 901 is further configured to receive a target CP length and a target TRP sent by the network device, in which the target CP length is the same as or different from the recommended CP length, and the target TRP is the same as or different from the recommended TRP.

In the embodiments of the present disclosure, the terminal may measure the signal quality of the candidate TRP based on the measurement configuration information and the reference signal of the candidate TRP, and determine the appropriate CP length and the appropriate TRP based on the measurement result, in which the appropriate CP length may guarantee to cover a multipath delay of the selected TRP, and the appropriate TRP may make the signal quality of the terminal better and improve stability of communication between the network device and the terminal.

Please refer to FIG. 10, which is a block diagram of a communication apparatus 1000 according to the embodiments of the present disclosure. The communication apparatus 1000 may be a network device, a terminal (such as the first terminal in the above method embodiments), a chip, a chip system, a processor, etc. that supports the network device to implement the method, or a chip, a chip system, a processor, etc. that supports the terminal to implement the method. The device may be used to implement the method in the above method embodiments. For details, please refer to the above method embodiments.

The communication apparatus 1000 may include one or more processors 1001. The processor 1001 may be a general purpose processor or a special purpose processor, for example, a baseband processor or a central processing unit. The baseband processor may be used to process communication protocols and communication data, and the central processing unit may be used to control communication apparatuses (such as a base station, a baseband chip, a terminal, a terminal chip, a DU or a CU, etc.), execute computer programs, and process computer program data.

Optionally, the communication apparatus 1000 may also include one or more memories 1002 for storing the computer program 1004. When the processor 1001 executes the computer program 1004, the communication apparatus 1000 is caused to implement the method in the above method embodiments. Optionally, the memory 1002 may also store data. The communication apparatus 1000 and the memory 1002 may be set up separately or integrated together.

Optionally, the communication apparatus 1000 may also include a transceiver 1005 and an antenna 1006. The transceiver 1005 may be called a transceiver unit, a transceiver machine, or a transceiver circuit, etc., to perform the receiving and sending function. The transceiver 1005 may include a receiver and a transmitter, and the receiver may be called a receiving machine or a receiving circuit, etc. to realize the receiving function; and the transmitter may be called a transmitting machine or a transmitting circuit, etc. to realize the sending function.

Optionally, the communication apparatus 1000 may also include one or more interface circuits 10010. The interface circuit 10010 is used to receive code instructions and transmit the code instructions to the processor 1001. The processor 1001 runs the code instructions to cause the communication apparatus 1000 to implement the method in the above method embodiments.

The communication apparatus 1000 is a terminal, configured to perform functions of the terminal in the above embodiments.

The communication apparatus 1000 is a network device, configured to perform functions of the network device in the above embodiments.

In one implementation, the processor 1001 may include a transceiver for performing the receiving and sending function. For example, the transceiver may be a transceiver circuit, or an interface, or an interface circuit. The transceiver circuit, the interface, or the interface circuit used to perform the receiving and sending function may be separate or integrated. The transceiver circuit, the interface or the interface circuit may be used for reading and writing code/data, or the transceiver circuit, the interface or the interface circuit may be used for the transmission of signals.

In one implementation, the processor 1001 may store a computer program 1003. When the computer program 1003 is running on the processor 1001, the communication apparatus 1000 is caused to implement the method in the above method embodiments. The computer program 1003 may be solidified in the processor 1001, in which case the processor 1001 may be implemented in hardware.

In one implementation, the communication apparatus 1000 includes a circuit that may perform the transmitting or receiving or communicating function in the above method embodiments. The processor and transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in the above embodiments may be a network device or a terminal (such as the first terminal in the method embodiments), but the scope of the communication apparatus in the disclosure is not limited to this, and the structure of the communication apparatus may not be restricted by FIG. 10. The communication apparatus may be an independent device or part of a larger device. For example, the communication apparatus may be:
(1) an independent IC, or a chip, or a chip system or a subsystem;
(2) a collection including one or more IC, optionally, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

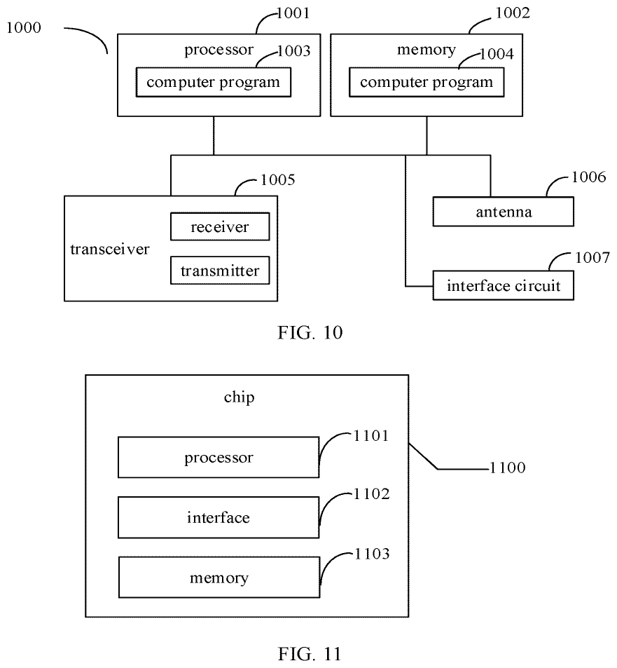

For the case where the communication apparatus may be a chip or a chip system, please refer to the block diagram of a chip in FIG. 11. The chip shown in FIG. 11 includes a processor 1101 and an interface 1102. There may be one or more processors 1101, and there may be one or more interfaces 1102.

For the case where the chip is used to perform the functions of the network device in the embodiments of the present disclosure:

the interface 1102, configured to send measurement configuration information to a terminal, in which the measurement configuration information indicates a candidate TRP for a channel quality measurement to the terminal; send a reference signal of the candidate TRP to the terminal, in which the reference signal is used to measure the candidate TRP; and receive a recommended CP length and/or a recommended TRP sent by the terminal, in which the recommended CP length and/or the recommended TRP is determined by the terminal based on a measurement result of the candidate TRP.

In some implementations, the recommended CP length is one CP length in a set of candidate CP lengths for the terminal, and the recommended TRP is one or more candidate TRPs.

In some implementations, the measurement configuration information includes at least one of:
identification information of the candidate TRP;
identification information of the reference signal of the candidate TRP;
a time-frequency resource location occupied by the reference signal of the candidate TRP;
a sequence of reference signals of the candidate TRP; or
a measurement quantity and a measurement parameter of the candidate TRP.

In some implementations, the interface 1102 is further configured to send indication information to the terminal, in which the indication information indicates a set of candidate CP lengths including one or more candidate CP lengths.

In some implementations, the interface 1102 is further configured to determine an index value of the set of candidate CP lengths; and
send the index value to the terminal as the indication information.

In some implementations, the interface 1102 is further configured to receive the identification information of the recommended TRP and/or a measurement result of the recommended TRP sent by the terminal.

In some implementations, the transceiver module 901 is configured to determine a target CP length and a target TRP selected by the network device, in which a target CP length is the same as or different from a recommended CP length, and the target TRP is the same as or different from the recommended TRP; perform transmission with the terminal based on the target CP length and the target TRP.

In some implementations, the interface 1102 is further configured to indicate the target CP length and the target TRP to the terminal.

For the case where the chip is used to perform the functions of the terminal in the embodiments of the present disclosure:
an interface 1102, configured to receive measurement configuration information of a candidate TRP sent by a network device, in which the measurement configuration information indicates the candidate TRP for a channel quality measurement to the terminal; receive a reference signal of the candidate TRP sent by the network device, and report a recommended CP length and a recommended TRP to the network device; and
a processing module 1101, configured to determine a measurement result of the candidate TRP according to the reference signal of the candidate TRP; and determine the recommended cyclic prefix (CP) length and the recommended TRP based on the measurement result of the candidate TRP.

In some implementations, the recommended CP length is one CP length in a set of candidate CP lengths for the terminal, and the recommended TRP is one or more candidate TRPs.

In some implementations, the measurement configuration information includes at least one of:
identification information of the candidate TRP;
identification information of the reference signal of the candidate TRP;
a time-frequency resource location occupied by the reference signal of the candidate TRP;
a sequence of reference signals of the candidate TRP; or
a measurement quantity and a measurement parameter of the candidate TRP.

In some implementations, the processing module 1101 is further configured to obtain an arrival time of the reference signal of the candidate TRP; and
determine the recommended CP length and the recommended TRP based on a measurement quantity and a measurement parameter of the candidate TRP and the arrival time.

In some implementations, the processing module 1101 is further configured to determine a set of recommended TRPs by selecting a first candidate TRP that satisfies a quality condition from a set of candidate TRPs according to the measurement quantity and the measurement parameter of the candidate TRP, in which there are a minimum number of first candidate TRPs included in the set of recommended TRPs, and the first candidate TRP is the recommended TRP; determine a reference CP length according to an arrival time of the reference signal of the first candidate TRP; and determine the recommended CP length from a set of candidate CP lengths of the terminal based on the reference CP length.

In some implementations, the processing module 1101 is further configured to determine an earliest arrival time and a latest arrival time from arrival times of reference signals of all first candidate TRPs; and determine a difference between the latest arrival time and the earliest arrival time as the reference CP length.

In some implementations, the processing module 1101 is further configured to determine, from the set of candidate CP lengths of the terminal, a candidate CP length that is greater than the reference CP length and has a smallest difference with the reference CP length, as the recommended CP length.

In some implementations, the processing module 1101 is further configured to determine a minimum CP length in a set of candidate CP lengths of the terminal; select a second candidate TRP that satisfies a signal quality condition from a set of candidate TRPs based on the measurement quantity and the measurement parameter; select a third candidate TRP from second candidate TRPs, in which an arrival time of a reference signal of the third candidate TRP falls within a time range of the minimum CP length; and determine the third candidate TRP as the recommended TRP and the minimum CP length as the recommended CP length.

In some implementations, the interface 1102 is further configured to receive indication information from the network device; and
the processing module 1101 is further configured to determine the set of candidate CP lengths based on the indication information, in which the set of candidate CP lengths includes one or more candidate CP lengths.

In some implementations, the interface 1102 is further configured to receive an index value of the set of candidate CP lengths sent by the network device; and
the processing module 1101 is further configured to determine the set of candidate CP lengths based on the index value.

In some implementations, the interface 1102 is further configured to report identification information of the recommended TRP and/or a measurement result of the recommended TRP to the network device.

In some implementations, the interface 1102 is further configured to directly report a measurement quantity of the recommended TRP to the network device; or report a difference between the measurement quantity and a measurement parameter of the recommended TRP to the network device.

In some implementations, the interface 1102 is further configured to receive a target CP length and a target TRP sent by the network device, in which the target CP length is the same as or different from the recommended CP length, and the target TRP is the same as or different from the recommended TRP.

Optionally, the chip also includes a memory 1103, which is used to store necessary computer programs and data.

In the embodiments of the present disclosure, the terminal may measure the signal quality of the candidate TRP based on the measurement configuration information and the reference signal of the candidate TRP, and determine the appropriate CP length and the appropriate TRP based on the measurement result, in which the appropriate CP length may guarantee to cover a multipath delay of the selected TRP, and the appropriate TRP may make the signal quality of the terminal better and improve stability of communication between the network device and the terminal.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the present disclosure.

In the embodiments of the present disclosure, a system for reporting information is also provided. The system includes the communication apparatus in the FIG. 9 as a terminal and the communication apparatus in the FIG. 9 as a network device, or, the system includes the communication apparatus in the FIG. 10 as a terminal and the communication apparatus in the FIG. 10 as a network device.

In the present disclosure, a non-transitory computer-readable storage medium for storing instructions is provided. When the instructions are executed by a computer, the function of any one of the above method embodiments is performed.

In the present disclosure, a computer program product is provided. When the computer program product is executed by a computer, the function of any one of the above method embodiments is performed.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a non-transitory computer-readable storage medium or transmitted from one non-transitory computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The non-transitory computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numbers like “first” and “second” in the present disclosure are only for the convenience of description, and are not used to limit the scope of the embodiments of the present disclosure, and also indicate a sequential order.

The term “at least one” in the present disclosure may also be described as one or more, and the more may be two, three, four, or more, which is not limited in the present disclosure. In the embodiment of the present disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Correspondence relationships indicated by tables in the present disclosure may be configured or predefined. Values of information in the tables are only examples, and may be configured as other values, which are not limited in the disclosure. When the correspondence relationship between information and parameters is configured, it is not always necessary to configure all correspondence relationships indicated in tables. For example, in the tables of the present disclosure, correspondence relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which may not be repeated here.

The above are only implementations of the disclosure. However, the protection scope of the disclosure is not limited here. Changes and substitutions that may be easily considered by those skilled in the art shall be contained within the protection scope of the present disclosure. Therefore, the protection scope of the disclosure shall be subject to the protection scope of claims.

1. A method for reporting information, performed by a network device, comprising:
sending measurement configuration information to a terminal, wherein the measurement configuration information indicates a candidate transmission reception point (TRP) for a channel quality measurement to the terminal;
sending a reference signal of the candidate TRP to the terminal, wherein the reference signal is used for the terminal to measure the candidate TRP; and
receiving at least one of a recommended cyclic prefix (CP) length or a recommended TRP sent by the terminal, wherein the at least one of the recommended CP length or the recommended TRP is determined by the terminal based on a measurement result of the candidate TRP.

2. The method of claim 1, wherein
the recommended CP length is one CP length in a set of candidate CP lengths for the terminal, and the recommended TRP comprises one or more candidate TRPs.

3. The method of claim 1, wherein the measurement configuration information includes at least one of:
identification information of the candidate TRP;
identification information of the reference signal of the candidate TRP;
a time-frequency resource location occupied by the reference signal of the candidate TRP;
a sequence of the reference signal of the candidate TRP; or
a measurement quantity and a measurement parameter of the candidate TRP.

4. The method of claim 1, further comprising:
sending indication information to the terminal, wherein the indication information indicates a set of candidate CP lengths comprising one or more candidate CP lengths.

5. The method of claim 4, wherein sending the indication information to the terminal comprises:
determining an index value of the set of candidate CP lengths; and
sending the index value to the terminal as the indication information.

6. The method of claim 1, further comprising:
receiving at least one of identification information of the recommended TRP and/or a measurement result of the recommended TRP sent by the terminal.

7. The method of claim 1, further comprising:
determining at least one of a target CP length or a target TRP selected by the network device, wherein a target CP length is the same as or different from the recommended CP length, and the target TRP is the same as or different from the recommended TRP;
performing transmission with the terminal based on the at least one of the target CP length or the target TRP; and
indicating the at least one of the target CP length or the target TRP to the terminal.

8. A method for reporting information, performed by a terminal, comprising:
receiving measurement configuration information of a candidate transmission reception point (TRP) sent by a network device, wherein the measurement configuration information indicates the candidate TRP for a channel quality measurement to the terminal;
receiving a reference signal of the candidate TRP sent by the network device, and determining a measurement result of the candidate TRP according to the reference signal of the candidate TRP; and
determining at least one of a recommended cyclic prefix (CP) length or a recommended TRP based on the measurement result of the candidate TRP, and reporting the at least one of the recommended CP length or the recommended TRP to the network device.

9. (canceled)

10. The method of claim 8, wherein the measurement configuration information comprises at least one of:
identification information of the candidate TRP;
identification information of the reference signal of the candidate TRP;
a mapping relationship between identification information of the candidate TRP and identification information of the reference signal of the candidate TRP;
a time-frequency resource location occupied by the reference signal of the candidate TRP;
a sequence of reference signals of the candidate TRP; or
a measurement quantity and a measurement parameter of the candidate TRP.

11. The method of claim 8, wherein determining the at least one of the recommended CP length or the recommended TRP comprises:
obtaining an arrival time of the reference signal of the candidate TRP; and
determining the at least one of the recommended CP length or the recommended TRP based on a measurement quantity and a measurement parameter of the candidate TRP and the arrival time.

12. The method of claim 11, wherein determining the at least one of the recommended CP length or the recommended TRP comprises at least one of:
determining a set of recommended TRPs by selecting a first candidate TRP that satisfies a quality condition from a set of candidate TRPs according to the measurement quantity and the measurement parameter, wherein there are a minimum number of first candidate TRPs comprised in the set of recommended TRPs, and the first candidate TRP is the recommended TRP; or
determining a reference CP length according to an arrival time of a reference signal of the first candidate TRP; and determining the recommended CP length from a set of candidate CP lengths of the terminal based on the reference CP length.

13. The method of claim 12, wherein determining the reference CP length comprises:
determining an earliest arrival time and a latest arrival time from arrival times of reference signals of all first candidate TRPs; and
determining a difference between the latest arrival time and the earliest arrival time as the reference CP length.

14. The method of claim 12, wherein determining the recommended CP length from the set of candidate CP lengths comprises:
determining, from the set of candidate CP lengths of the terminal, a candidate CP length that is greater than the reference CP length and has a smallest difference with the reference CP length, as the recommended CP length.

15. The method of claim 11, wherein determining the at least one of the recommended CP length or the recommended TRP comprises:
determining a minimum CP length in a set of candidate CP lengths of the terminal;
selecting a second candidate TRP that satisfies a signal quality condition from a set of candidate TRPs based on the measurement quantity and the measurement parameter;
selecting a third candidate TRP from second candidate TRPs, wherein an arrival time of a reference signal of the third candidate TRP falls within a time range of the minimum CP length; and
determining the third candidate TRP as the recommended TRP and the minimum CP length as the recommended CP length.

16. The method of claim 12, further comprising:
receiving indication information from the network device; and
determining the set of candidate CP lengths based on the indication information, wherein the set of candidate CP lengths comprises one or more candidate CP lengths.

17. (canceled)

18. The method of claim 8, further comprising:
reporting at least one of identification information of the recommended TRP or a measurement result of the recommended TRP to the network device.

19. The method of claim 18, further comprising one of:
directly reporting a measurement quantity of the recommended TRP to the network device; or
reporting a difference between a measurement quantity and a measurement parameter of the recommended TRP to the network device.

20. The method of claim 8, further comprising:
receiving at least one of a target CP length or a target TRP sent by the network device, wherein the target CP length is the same as or different from the recommended CP length, and the target TRP is the same as or different from the recommended TRP.

21-22. (canceled)

23. A communication apparatus, comprising a processor and a memory for storing a computer program, wherein when the computer program stored in the memory is executed by the processor, the processor is configured to:
send measurement configuration information to a terminal, wherein the measurement configuration information indicates a candidate transmission reception point (TRP) for a channel quality measurement to the terminal;
send a reference signal of the candidate TRP to the terminal, wherein the reference signal is used for the terminal to measure the candidate TRP; and
receive at least one of a recommended cyclic prefix (CP) length or a recommended TRP sent by the terminal, wherein the at least one of the recommended CP length or the recommended TRP is determined by the terminal based on a measurement result of the candidate TRP.

24. A communication apparatus, comprising a processor and a memory for storing a computer program, wherein when the computer program stored in the memory is executed by the processor, the processor is configured to implement the method of claim 8.

25-28. (canceled)
